(19) United States
(12) Patent Application Publication
(10) Pub. No.: US 2018/0273024 A1
(43) Pub. Date: Sep. 27, 2018

(54) VEHICLE BEHAVIOR CONTROL DEVICE

(71) Applicant: MAZDA MOTOR CORPORATION, Hiroshima (JP)

(72) Inventors: Daisuke UMETSU, Hiroshima-shi, Hiroshima (JP); Osamu SUNAHARA, Hiroshima-shi, Hiroshima (JP)

(73) Assignee: MAZDA MOTOR CORPORATION, Hiroshima (JP)

(21) Appl. No.: 15/764,236

(22) PCT Filed: Nov. 2, 2016
(86) PCT No.: PCT/JP2016/082619

§ 371 Date: Mar. 28, 2018

(30) Foreign Application Priority Data
Nov. 6, 2015 (JP) 2015-218640

(51) Int. Cl. B60W 30/02; B62D 6/00; B62D 5/04

(52) U.S. Cl. CPC B60W 30/02; B62D 15/025; B62D 5/0463; B62D 6/005

(57) ABSTRACT

Provided is a vehicle behavior control device capable of performing a vehicle behavior control to accurately realize vehicle behavior intended by a driver, without causing the driver to feel uncomfortable in vehicle behavior during straight-ahead traveling. The vehicle behavior control device comprises a PCM (18) configured to control the vehicle (1) to reduce torque for driving the vehicle, according to a steering speed of the vehicle. The PCM is configured, under the condition that the steering speed is greater than a predetermined threshold Ts, and when a steering angle of the vehicle is increasing, and the steering speed is increasing, to control to gradually increase an amount of reduction of the torque for driving the vehicle, along with an increase in the steering speed, and, under the condition that the steering speed is equal to or less than the threshold Ts, to control to stop the reduction of the torque.

### TECHNICAL FIELD

The present invention relates to a vehicle behavior control device, and more particularly to a vehicle behavior control device for controlling behavior of a vehicle having steerable front road wheels.

### BACKGROUND ART

Heretofore, there has been known a control device capable of, in a situation where behavior of a vehicle becomes unstable due to road wheel slip or the like, controlling the vehicle behavior to enable a safe traveling (e.g., an antiskid brake device). Specifically, there has been known a control device operable to detect the occurrence of vehicle understeer or oversteer behavior during vehicle cornering or the like, and apply an appropriate degree of deceleration to one or more road wheels so as to suppress such behavior.

There has also been known a vehicle motion control device operable to adjust a degree of deceleration during vehicle cornering to thereby adjust a load to be applied to front road wheels as steerable road wheels so as to enable a series of manipulations (braking, turning of a steering wheel, accelerating, turning-back of the steering wheel, etc.) by a driver during vehicle cornering under a normal traveling condition to be performed naturally and stably, differently from the aforementioned control for improving safety in a traveling condition causing the vehicle behavior to become unstable (see, for example, the following Patent Document 1).

Further, there has been proposed a vehicle behavior control device operable to reduce a vehicle driving force according to a yaw rate-related quantity (e.g., yaw acceleration) corresponding to manipulation of a steering wheel by a driver, thereby making it possible to quickly generate vehicle deceleration in response to start of the steering wheel manipulation by the driver and thus quickly apply a sufficient load to front road wheels as steerable road wheels (see, for example, the following Patent Document 2). In this vehicle behavior control device, in response to start of the steering wheel manipulation, a load is quickly applied to the front road wheels to cause an increase in frictional force between each of the front road wheels and a road surface and thus an increase in cornering force of the front road wheels, thereby providing an improved turn-in ability of a vehicle in an initial phase after entering a curve, and an improved responsivity with respect to turning manipulation of a steering wheel. This makes it possible to realize vehicle behavior just as intended by the driver.

### CITATION LIST

### Patent Document

Patent Document 1: JP 2011-88576A

Patent Document 2: JP 2014-166014A

### SUMMARY OF INVENTION

### Technical Problem

In reality, however, even during straight-ahead traveling of a vehicle, a small manipulation of a steering wheel can be necessary to maintain a straight-ahead traveling state. The vehicle behavior control device described in the Patent Document 2 is operable to reduce the vehicle driving force according to the yaw rate-related quantity corresponding to the steering wheel manipulation even when it is such a small manipulation of the steering wheel during straight-ahead traveling of the vehicle. That is, the turn-in ability of the vehicle responsive to the steering wheel manipulation is improved even though a driver intends to maintain the straight-ahead traveling state, so that the driver can feel that vehicle behavior is excessively sensitive to the steering wheel manipulation during straight-ahead traveling. Moreover, the reduction in the vehicle driving force causes an increase in cornering force of the front road wheels, and accordingly causes an increase in reaction force against steering, so that the driver is likely to feel that the steering wheel manipulation during straight-ahead traveling is too heavy. As above, the vehicle behavior control device described in the Patent Document 2 is likely to undesirably cause a driver to feel uncomfortable in vehicle behavior during straight-ahead traveling.

The present invention has been made to solve the above conventional problem, and an object thereof is to provide a vehicle behavior control device capable of performing a vehicle behavior control to accurately realize vehicle behavior intended by a driver, without causing the driver to feel uncomfortable in vehicle behavior during straight-ahead traveling.

### Solution to Technical Problem

In order to achieve the above object, the present invention provides a vehicle behavior control device for controlling behavior of a vehicle having steerable front road wheels. The vehicle behavior control device comprises a steering angle sensor and a driving force control part configured to control the vehicle to reduce driving force for the vehicle, according to yaw rate-related quantity which is related to a yaw rate of the vehicle, wherein the driving force control part is configured, under the condition that the yaw rate-related quantity is greater than a predetermined threshold, and when a steering angle of the vehicle is increasing, and the yaw rate-related quantity is increasing, to control the vehicle to gradually increase an amount of reduction of the driving force for the vehicle, along with an increase in the yaw rate-related quantity, and, under the condition that the yaw rate-related quantity is equal to or less than the threshold, to control to stop the reduction of the driving force.

In the vehicle behavior control device of the present invention having the above feature, the driving force control part is configured, under the condition that the yaw rate-related quantity is greater than a predetermined threshold, to control the vehicle to reduce the driving force for the vehicle, according to the yaw rate-related quantity, and, under the condition that the yaw rate-related quantity is equal to or less than the threshold, to control to stop the reduction of the driving force. Thus, under the condition that the yaw rate-related quantity is greater than the predetermined threshold, the driving force can be reduced by an amount according to the yaw rate-related quantity to thereby add deceleration to the vehicle to quickly apply a load to front road wheels, so that it is possible to control vehicle behavior with good responsivity with respect to intentional manipulation of the steering wheel by a driver. On the other hand, under the condition that the yaw rate-related quantity is equal to or less than the threshold, it is possible to suppress a situation where the vehicle excessively responds to a small manipulation of the steering wheel. This makes it possible to perform the vehicle behavior control to accurately realize vehicle behavior intended by a driver, without causing the driver to feel uncomfortable in vehicle behavior during straight-ahead traveling.

Preferably, in the vehicle behavior control device of the present invention, the yaw rate-related quantity is a steering speed of the vehicle, wherein the threshold of the steering speed used by the driving force control part to stop the reduction of the driving force is set in the range of 3 deg/s to 5 deg/s.

According to this feature, the threshold is set in the range of 3 deg/s to 5 deg/s, so that it is possible to prevent a situation where a driver feels that vehicle behavior responsive to the steering manipulation during straight-ahead traveling is too sensitive and thus straight-ahead traveling performance has degraded, or a situation where a driver feels that responsivity of the vehicle with respect to the steering wheel manipulation during straight-ahead traveling is poor or unreliable. Further, it is possible to prevent the driver from feeing that the steering wheel manipulation during straight-ahead traveling is too heavy or discontinuous. This makes it possible to perform the vehicle behavior control to accurately realize vehicle behavior intended by the driver, while reliably preventing the disadvantage of causing the driver to feel uncomfortable in vehicle behavior during straight-ahead traveling.

More preferably, in the above vehicle behavior control device, the threshold is set at 4 deg/s.

According to this feature, the threshold is set at 4 deg/s, so that it is possible to more reliably prevent a situation where a driver feels that vehicle behavior responsive to the steering wheel manipulation during straight-ahead traveling is too sensitive and thus straight-ahead traveling performance has degraded, or a situation where a driver feels that responsivity of the vehicle with respect to the steering wheel manipulation during straight-ahead traveling is poor or unreliable. Further, it is possible to more reliably prevent the driver from feeing that the steering wheel manipulation during straight-ahead traveling is too heavy or discontinuous. This makes it possible to perform the vehicle behavior control to accurately realize vehicle behavior intended by the driver, while more reliably preventing the disadvantage of causing the driver to feel uncomfortable in vehicle behavior during straight-ahead traveling.

Preferably, in the vehicle behavior control device of the present invention, the driving force control part is configured, under the condition that the yaw rate-related quantity is greater than the threshold, and when the steering angle of the vehicle is increasing, and the yaw rate-related quantity is increasing, to control the vehicle to gradually reduce an increase rate of the driving force reduction amount along with an increase in the yaw rate-related quantity.

According to this feature, the driving force control part is configured to control the vehicle to gradually reduce an increase rate of the driving force reduction amount along with an increase in the yaw rate-related quantity, so that, when steering of the vehicle is started and thus the yaw rate-related quantity of the vehicle starts increasing, the driving force reduction amount can be quickly increased to thereby quickly add deceleration to the vehicle at start of steering of the vehicle to quickly apply a sufficient load to front road wheels as steerable road wheels. As a result, a frictional force between each of the front road wheels as steerable road wheels and a road surface is increased, and thus a cornering force of the front road wheels is increased, so that it is possible to improve turn-in ability of the vehicle in an initial phase after entering a curve. This makes it possible to improve responsiveness to the turning manipulation of the steering wheel, while reliably preventing the disadvantage of causing the driver to feel uncomfortable in vehicle behavior during straight-ahead traveling.

### Effect of Invention

The vehicle behavior control device of the present invention is capable of performing a vehicle behavior control to accurately realize vehicle behavior intended by a driver, without causing the driver to feel uncomfortable in vehicle behavior during straight-ahead traveling.

### BRIEF DESCRIPTION OF DRAWINGS

FIG. 1 is a block diagram depicting an entire configuration of a vehicle equipped with a vehicle behavior control device according to one embodiment of the present invention.

FIG. 2 is a block diagram depicting an electrical configuration of the vehicle behavior control device according to this embodiment.

FIG. 3 is a flowchart of an engine control processing routine to be executed by the vehicle behavior control device according to this embodiment, so as to control an engine.

FIG. 4 is a flowchart of a torque reduction amount determination processing subroutine to be executed by the vehicle behavior control device according to this embodiment, so as to determine a torque reduction amount.

FIG. 5 is a map presenting a relationship between a steering speed, and a target additional deceleration to be determined by the vehicle behavior control device according to this embodiment.

FIG. 6 consists of seven time charts each presenting a temporal change in a respective one of various parameters regarding engine control to be performed by the vehicle behavior control device according to this embodiment during turning of a vehicle equipped with this vehicle behavior control device, wherein: chart (a) is a top plan view schematically depicting the vehicle which is turning in a clockwise direction; chart (b) presents a change in steering angle of the vehicle which is turning in the clockwise direction as depicted in the chart (a); chart (c) presents a change in steering speed of the vehicle which is turning in the clockwise direction as depicted in the chart (a); chart (d) presents a change in additional deceleration determined based on the steering speed depicted in the chart (c); chart (e) presents a change in torque reduction amount determined based on the additional deceleration depicted in the chart (d); chart (f) presents a change in final target torque determined based on a basic target torque and the torque reduction amount; and chart (g) presents a change in yaw rate (actual yaw rate) generated in the vehicle when the engine control is performed based on the final target torque depicted in the chart (f), and a change in actual yaw rate generated in the vehicle when the engine control based on the torque reduction amount determined by a torque reduction amount-determining part is not performed.

FIG. 7 is a graph presenting a driver's subjective evaluation for vehicle behavior during straight-ahead traveling, performed by variously changing a threshold Ts.

### DESCRIPTION OF EMBODIMENTS

With reference to the accompanying drawings, a vehicle behavior control device according to one embodiment of the present invention will now be described.

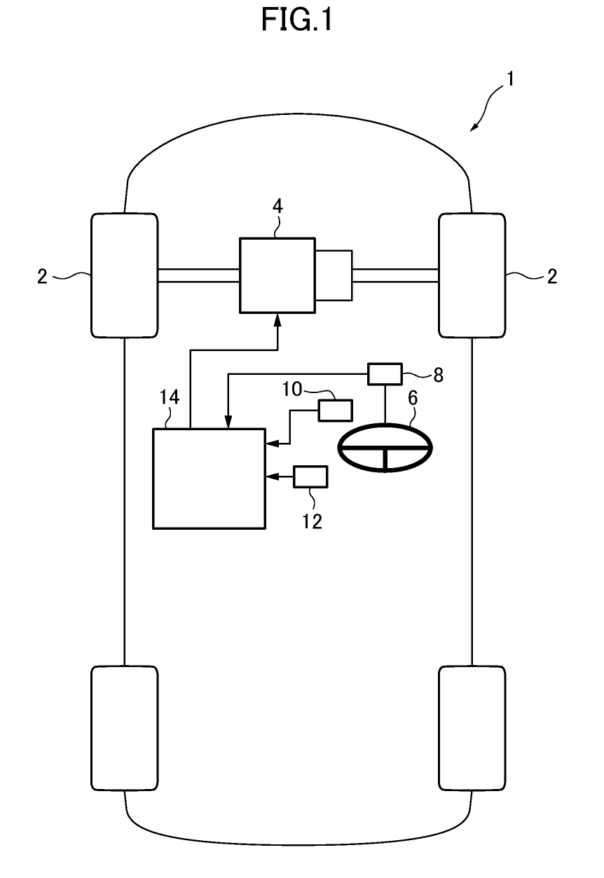

First of all, with reference to FIG. 1, a vehicle equipped with the vehicle behavior control device according to this embodiment will be described. FIG. 1 is a block diagram depicting an entire configuration of the vehicle equipped with the vehicle behavior control device according to this embodiment.

In FIG. 1, the reference sign 1 denotes the vehicle equipped with the vehicle behavior control device according to this embodiment. A vehicle body of the vehicle 1 has a front portion on which an engine 4 for driving drive road wheels (in the example depicted in FIG. 1, right and left front road wheels 2) is mounted. The engine 4 is an internal combustion engine such as a gasoline engine or a diesel engine.

The vehicle 1 has: a steering angle sensor 8 for detecting a rotational angle of a steering wheel 6 (steering angle); an accelerator position sensor 10 for detecting an amount of depression of an accelerator pedal (accelerator position); and a vehicle speed sensor 12 for detecting a vehicle speed. These sensors are operable to output respective detection values to a PCM (Power-train Control Module) 14.

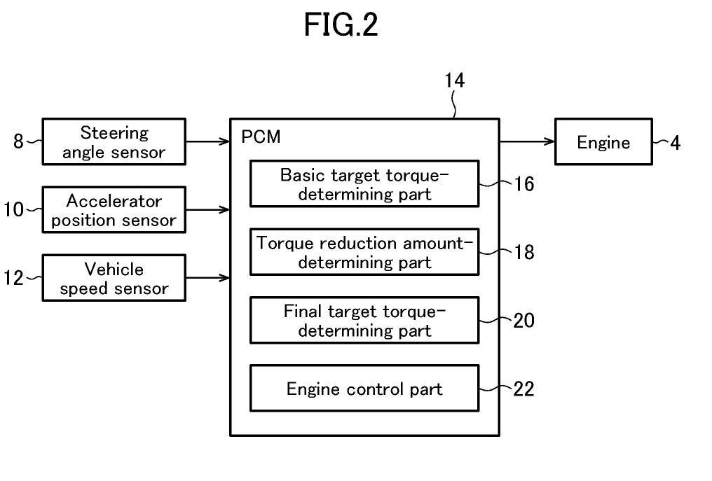

Next, with reference to FIG. 2, an electrical configuration of the vehicle behavior control device according to this embodiment will be described. FIG. 2 is a block diagram depicting the electrical configuration of the vehicle behavior control device according to this embodiment.

The PCM 14 (vehicle behavior control device, driving force control part, automotive vehicle control device, or controller) according to this embodiment is configured to, based on detection signals output from the above sensors 8 to 12, and detection signals output from various other sensors for detecting an operation state of the engine 4, generate and output control signals to perform controls with respect to various components (e.g., a throttle valve, a turbocharger, a variable valve mechanism, an ignition unit, a fuel injection valve, and an EGR unit) of the engine 4.

The PCM 14 comprises: a basic target torque-determining part 16 configured to determine a basic target torque based on a driving state of the vehicle 1 including manipulation of the accelerator pedal; a torque reduction amount-determining part 18 configured to determine a torque reduction amount for adding deceleration to the vehicle 1 based on a yaw rate-related quantity of the vehicle 1; a final target torque-determining part 20 configured to determine a final target torque based on the basic target torque and the torque reduction amount; and an engine control part 22 for controlling the engine 4 to cause the engine 4 to output the final target torque. This embodiment will be described based on an example where the torque reduction amount-determining part 18 is configured to use a steering speed (steering angular speed) of the vehicle 1 as the yaw rate-related quantity.

The above components of the PCM 14 are functionally realized by a computer which comprises: a CPU; various programs (including a basic control program such as an OS, and an application program capable of being activated on the OS to realize a specific function) to be interpreted and executed by the CPU; and an internal memory such as ROM or RAM storing therein the programs and a variety of data.

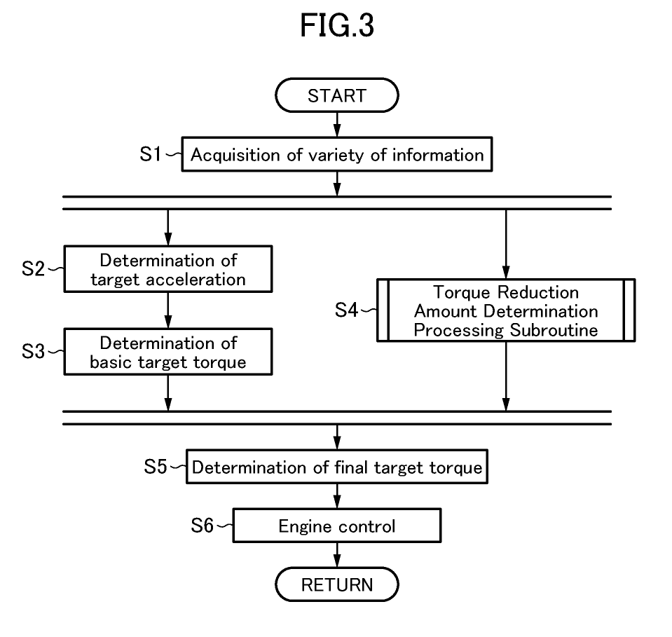

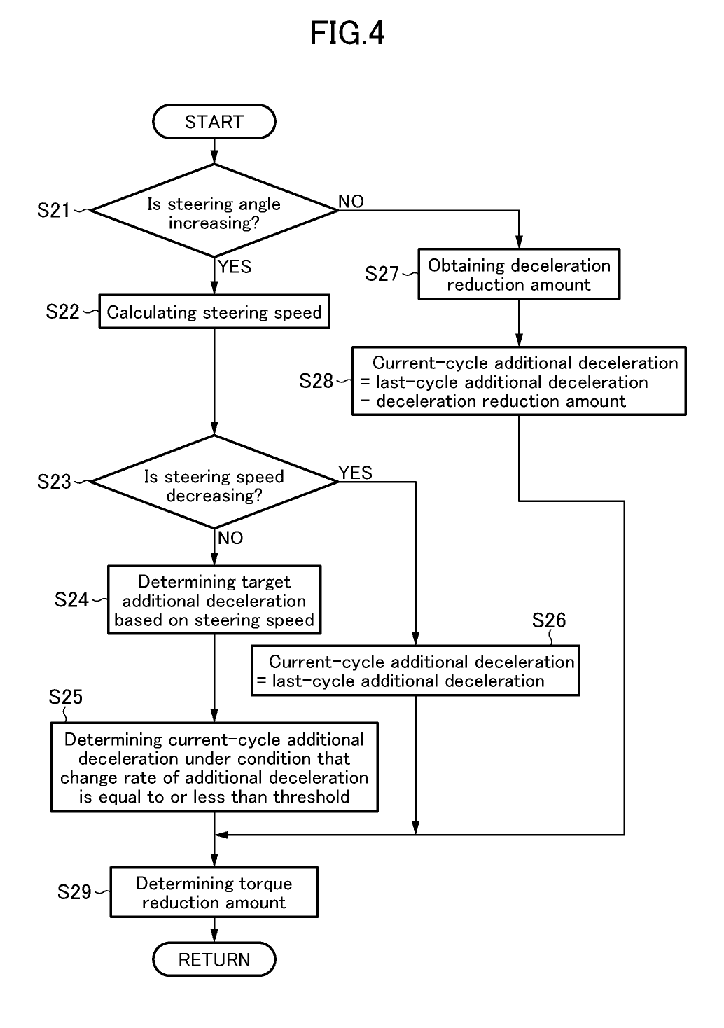

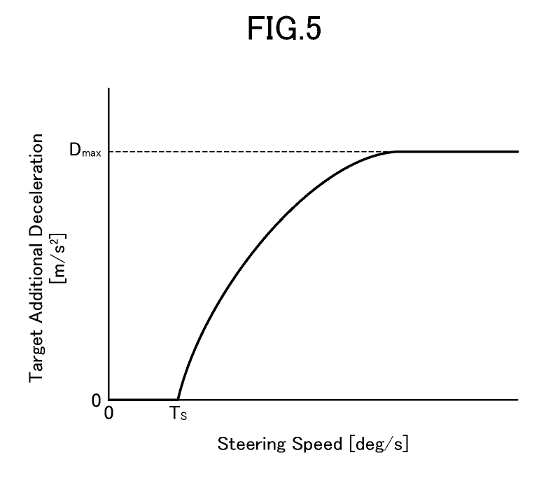

Next, with reference to FIGS. 3 to 5, a processing routine to be executed by the vehicle behavior control device will be described. FIG. 3 is a flowchart of an engine control processing routine to be executed by the vehicle behavior control device according to this embodiment, so as to control the engine 4, and FIG. 4 is a flowchart of a torque reduction amount determination processing subroutine to be executed by the vehicle behavior control device according to this embodiment, so as to determine the torque reduction amount. FIG. 5 is a map presenting a relationship between the steering speed, and a target additional deceleration to be determined by the vehicle behavior control device according to this embodiment.

The engine control processing routine in FIG. 3 is activated when an ignition switch of the vehicle 1 is turned on to apply electric power to the vehicle behavior control device, and repeatedly executed with a given cycle period.

As depicted in FIG. 3, upon start of the engine control processing routine, in step S1, the PCM 14 operates to acquire a variety of information about the driving state of the vehicle 1. Specifically, the PCM 14 operates to acquire, as information about the driving state, detection signals output from the aforementioned sensors, including the steering angle detected by the steering angle sensor 8, the accelerator position detected by the accelerator position sensor 10, the vehicle speed detected by the vehicle speed sensor 12, and a gear stage currently set in a transmission of the vehicle 1.

Subsequently, in step S2, the basic target torque-determining part 16 of the PCM 14 operates to set a target acceleration based on the driving state of the vehicle 1 including the manipulation of the accelerator pedal, acquired in the step S1. Specifically, the basic target torque-determining part 16 operates to select, from a plurality of acceleration characteristic maps defined with respect to various vehicle speeds and various transmission gear stages (the maps are preliminarily created and stored in a memory or the like), one acceleration characteristic map corresponding to a current vehicle speed and a current transmission gear stage, and determine a target acceleration corresponding to a current accelerator position by referring to the selected acceleration characteristic map.

Subsequently, in step S3, the basic target torque-determining part 16 operates to determine the basic target torque of the engine 4 for realizing the target acceleration determined in the step S2. In this embodiment, the basic target torque-determining part 16 operates to determine the basic target torque within a torque range outputtable by the engine 4, based on current vehicle speed, transmission gear stage, road grade, road surface mu (μ), etc.

In parallel to the processings in the steps S2 and S3, in step S4, the torque reduction amount-determining part 18 operates to execute the torque reduction amount determination processing subroutine for determining the torque reduction amount for adding deceleration to the vehicle 1, based on manipulation of the steering wheel. This torque reduction amount determination processing subroutine will be described with reference to FIG. 4.

As depicted in FIG. 4, upon start of the torque reduction amount determination processing routine, in step S21, the torque reduction amount-determining part 18 operates to determine whether or not an absolute value of the steering angle acquired in the step S1 is increasing. As a result, when the absolute value of the steering angle is increasing, the subroutine proceeds to step S22. In the step S22, the torque reduction amount-determining part 18 operates to calculate the steering speed based on the steering angle acquired in the step S1.

Subsequently, in step S23, the torque reduction amount-determining part 18 operates to determine whether or not an absolute value of the calculated steering speed is decreasing.

As a result, when the absolute value of the calculated steering speed is not decreasing, i.e., the absolute value of the calculated steering speed is increasing or the absolute value of the steering speed does not change, the subroutine proceeds to step S24. In the step S24, the torque reduction amount-determining part 18 operates to determine a target additional deceleration based on the calculated steering speed. This target additional deceleration is deceleration to be added to the vehicle 1 according to the steering wheel manipulation, so as to accurately realize vehicle behavior intended by a driver.

Specifically, the torque reduction amount-determining part 18 operates to obtain a value of the target additional deceleration corresponding to the steering speed calculated in the step S22, based on a relationship between the target additional deceleration and the steering speed, represented by the map in FIG. 5.

In FIG. 5, the horizontal axis represents the steering speed, and the vertical axis represents the target additional deceleration. As depicted in FIG. 5, under the condition that the steering speed is equal to or less than a threshold Ts, a corresponding value of the target additional deceleration is 0. That is, under the condition that the steering speed is equal to or less than the threshold Ts, the PCM 14 operates to stop control of adding deceleration to the vehicle 1 (specifically, to strop control of reducing an output torque of the engine 4) based on the steering wheel manipulation.

On the other hand, under the condition that the steering speed is greater than the threshold Ts, a value of the target additional deceleration corresponding to the steering speed gradually comes closer to a given upper limit value Dmax (e.g., 1 m/s²). That is, along with an increase in the steering speed, the target additional deceleration gradually increases, and an increase rate of the target additional deceleration gradually decreases.

Subsequently, in the step S25, the torque reduction amount-determining part 18 operates to determine an additional deceleration in the current processing cycle (current-cycle additional deceleration), under the condition that the increase rate of the additional deceleration is equal to or less than a threshold Rmax (e.g., 0.5 m/s³).

Specifically, the torque reduction amount-determining part 18 operates to, when an increase rate from the additional deceleration determined in the last processing cycle (last-cycle additional deceleration) to the target additional deceleration obtained in the step S24 in the current processing cycle is equal to or less than the threshold Rmax, determine the target additional deceleration obtained in the step S24, as the current-cycle additional deceleration.

On the other hand, the torque reduction amount-determining part 18 operates to, when the increase rate from the last-cycle additional deceleration to the target deceleration obtained in the step S24 in the current processing cycle is greater than the threshold Rmax, determine, as the current-cycle additional deceleration, a value obtained by increasing the last-cycle additional deceleration at the increase rate Rmax for the given cycle period.

Referring to the step S23 again, when the absolute value of the steering speed is decreasing, the subroutine proceeds to step S26. In the step S26, the torque reduction amount-determining part 18 operates to determine the last-cycle additional deceleration as the current-cycle additional deceleration. That is, when the absolute value of the steering speed is decreasing, a value of the additional deceleration corresponding to a maximum value of the steering speed (i.e., a maximum value of the additional deceleration) is maintained.

Referring to the step S21 again, when the absolute value of the steering angle is not increasing (i.e., is maintained constant or is decreasing), the subroutine proceeds to step S27. In the step S27, the torque reduction amount-determining part 18 operates to obtain an amount (deceleration reduction amount) by which the last-cycle additional deceleration is to be reduced in the current processing cycle. For example, the deceleration reduction amount may be calculated based on a constant reduction rate (e.g., 0.3 m/s³) preliminarily stored in a memory or the like. Alternatively, the deceleration reduction amount may be calculated based on a reduction rate determined according to the driving state of the vehicle 1 acquired in the step S1 and/or the steering speed calculated in Step S22.

Subsequently, in step S28, the torque reduction amount-determining part 18 operates to determine the current-cycle additional deceleration by subtracting the deceleration reduction amount obtained in the step S27 from the last-cycle additional deceleration.

After completion of the step S25, S26 or S28, in step S29, the torque reduction amount-determining part 18 operates to determine the torque reduction amount, based on the current-cycle additional deceleration determined in the step S25, S26 or S28. Specifically, the torque reduction amount-determining part 18 operates to determine a value of the torque reduction amount required for realizing the current-cycle additional deceleration, based on the current vehicle speed, transmission gear stage, road grade and others acquired in the Step S1. After completion of the step S29, the torque reduction amount-determining part 18 operates to terminate the torque reduction amount determination processing subroutine, and the subroutine returns to the main routine.

Returning to FIG. 3 again, after completion of the processings in the steps S2, S3 and the torque reduction amount determination processing subroutine in the step S4, in step S5, the final target torque-determining part 20 operates to subtract the torque reduction amount determined in the torque reduction amount determination processing subroutine in the step S4 from the basic target torque after being subjected to smoothing in the step S3, to thereby determine the final target torque.

Subsequently, in step S6, the engine control part 22 operates to control the engine 4 to cause the engine 4 to output the final target torque set in the step S5. Specifically, the engine control part 22 operates to, based on the final target torque set in the step S5 and an engine speed, determine various state quantities (e.g., air charge amount, fuel injection amount, intake air temperature, and oxygen concentration) required for realizing the final target torque set in the step S5, and then, based on the determined state quantities, control a plurality of actuators for driving various components of the engine 4. In this case, before performing the control, the engine control part 22 operates to set a limit value or range with respect to each of the state quantities, and set a control amount of each of the actuators to enable its related state value to preserve limitation by the limit value or range.

After completion of the step S6, the PCM 14 operates to terminate the engine control processing routine.

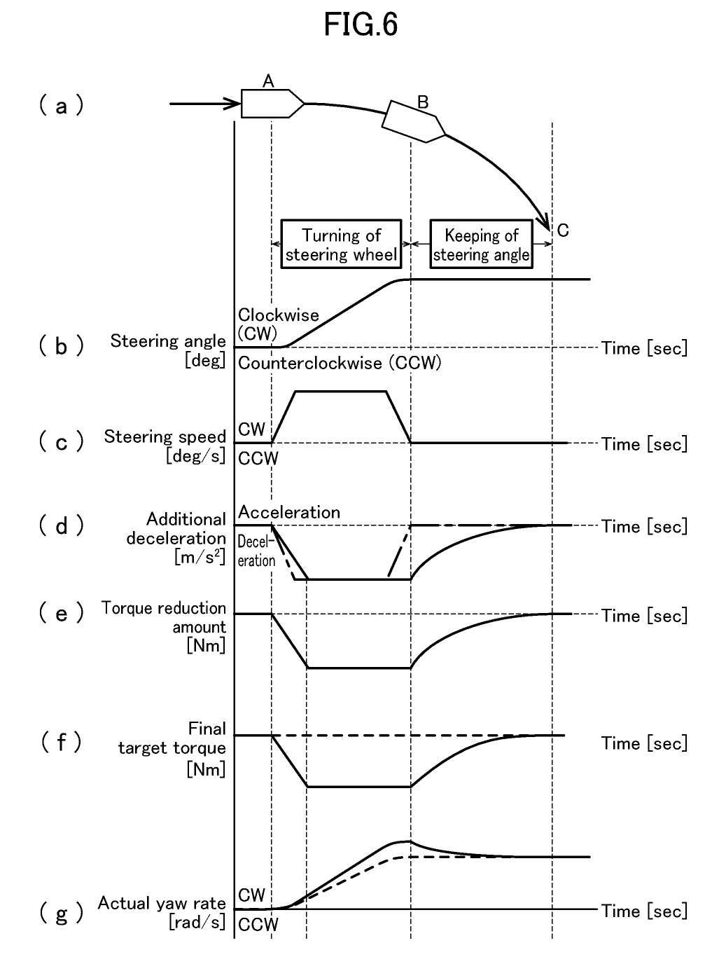

Next, with reference to FIG. 6, an operation of the vehicle behavior control device according to this embodiment will be described. FIG. 6 consists of seven time charts (a) to (g) each presenting a temporal change of a respective one of various parameter pertaining to the engine control to be performed by the vehicle behavior control device according to this embodiment during turning of the vehicle 1 equipped with this vehicle behavior control device.

The chart (a) is a top plan view schematically depicting the vehicle 1 which is turning in a clockwise direction. As depicted in the chart (a), the vehicle 1 starts to turn from a position A, and continues to turn from a position B to a position C in the clockwise direction at a constant steering angle.

The chart (b) presents a change in the steering angle of the vehicle 1 which is turning in the clockwise direction as depicted in the chart (a). In the chart (b), the horizontal axis represents time, and the vertical axis represents the steering angle.

As presented in the chart (b), clockwise steering is started at the position A, and then, along with additional turning manipulation of the steering wheel, a clockwise steering angle gradually increases and reaches a maximum value at the position B. Subsequently, the steering angle is maintained constant until the vehicle reaches the position C (Keeping of the steering angle).

The chart (c) presents a change in the steering speed of the vehicle 1 which is turning in the clockwise direction as depicted in the chart (a). In the chart (c), the horizontal axis represents time, and the vertical axis represents the steering speed.

The steering speed of the vehicle 1 is expressed as a temporal differentiation of the steering angle of the vehicle 1. That is, as presented in the chart (c), when clockwise steering is started at the position A, a clockwise steering speed arises and is maintained approximately constant in an intermediate zone between the position A and the position B. Then, when the clockwise steering speed decreases, and the clockwise steering angle reaches the maximum value at the position B, the steering speed becomes 0. Then, when the clockwise steering angle is maintained during traveling from the position B to the position C, the steering speed is kept at 0.

The chart (d) presents a change in the additional deceleration determined based on the steering speed presented in the chart (c). In the chart (d), the horizontal axis represents time, and the vertical axis represents the additional deceleration. In the chart (d), the solid line indicates a change in the additional deceleration determined in the torque reduction amount determination processing subroutine in FIG. 4, and the one-dot chain line indicates a change in the target additional deceleration based on the steering speed. As with the change in the steering speed presented in the chart (c), the target additional deceleration indicated by the one-dot chain line starts to increase from the position A, and is maintained approximately constant in the intermediate zone between the position A and the position B, whereafter it decreases and becomes 0 at the position B.

As described with reference to FIG. 4, when the absolute value of the steering angle is determined in the step S21 to be increasing, and the absolute value of the steering speed is determined in the step S23 to be not decreasing, i.e., the absolute value of the steering speed is determined in the step S23 to be increasing or to have no change, the torque reduction amount-determining part 18 operates in the step S24 to obtain the target additional deceleration based on the steering speed. Subsequently, in the step S25, the torque reduction amount-determining part 18 operates to determine an additional deceleration in each processing cycle, under the condition that the increase rate of the additional deceleration is equal to or less than the threshold Rmax.

The chart (d) presents an example in which the increase rate of the target additional deceleration starting to increase from the position A is greater than the threshold Rmax. In this case, the torque reduction amount-determining part 18 operates to increase the additional deceleration at an increase rate equal to the upper limit Rmax (i.e., at an increase rate providing a gentler slope than that of the target additional deceleration indicated by the one-dot chain line). Then, when the target additional deceleration is maintained approximately constant in the intermediate zone between the position A and the position B, the torque reduction amount-determining part 18 operates to determine the additional deceleration such that it becomes equal to the target additional deceleration.

Then, when the absolute value of the steering angle is determined in the step S21 to be increasing, and the steering speed is determined in the step S23 to be decreasing, the torque reduction amount-determining part 18 operates to maintain a value of the additional deceleration corresponding to the maximum steering speed, as mentioned above. Specifically, in the chart (d), when the steering speed decreases toward the position B, the target additional deceleration indicated by the one-dot chain line also decreases along therewith, but the additional deceleration indicated by the solid line is maintained at its maximum value, until the vehicle reaches the position B.

On the other hand, when the absolute value of the steering angle is determined, in the step S21 depicted in FIG. 4, to be maintained constant or to be decreasing, the torque reduction amount-determining part 18 operates to obtain the deceleration reduction amount in the step S27, and reduce the additional deceleration by the obtained deceleration reduction amount, as mentioned above. In the chart (d), the torque reduction amount-determining part 18 operates to reduce the additional deceleration to cause a reduction rate of the additional deceleration to become gradually smaller, i.e., to cause a slope of the solid line indicative of a change in the additional deceleration to become gradually gentler.

The chart (e) presents a change in the torque reduction amount determined based on the additional deceleration presented in the chart (d). In the chart (e), the horizontal axis represents time, and the vertical axis represents the torque reduction amount.

As mentioned above, the torque reduction amount-determining part 18 operates to determine a value of the torque reduction amount required for realizing the current-cycle additional deceleration, based on parameters such as current vehicle speed, transmission gear stage and road grade. Thus, in the case where respective values of these parameters are constant, the torque reduction amount is determined such that it changes in the same pattern as that of the additional deceleration presented in the chart (d).

The chart (f) presents a change in in the final target torque determined based on the basic target torque and the torque reduction amount. In the chart (f), the horizontal axis represents time, and the vertical axis represents torque. Further, in the chart (f), the dotted line indicates the basic target torque, and the solid line indicates the final target torque.

As described with reference to FIG. 3, the final target torque-determining part 20 operates to subtract the torque reduction amount determined by the torque reduction amount determination processing subroutine in the step S4, from the basic target torque determined in the step S3, to thereby determine the final target torque.

The chart (g) presents a change in yaw rate (actual yaw rate) generated in the vehicle 1 when control of the engine 4 is performed based on the final target torque presented in the chart (f), and a change in actual yaw rate generated in the vehicle 1 when control of the engine 4 based on the torque reduction amount determined by the torque reduction amount-determining part is not performed (i.e., control of the engine 4 is performed to realize the basic target torque indicated by the dotted line in the chart (f)). In the chart (g), the horizontal axis represents time, and the vertical axis represents yaw rate. Further, in the chart (g), the solid line indicates a change in the actual yaw rate generated when the control of the engine 4 is performed to realize the final target torque, and the dotted line indicates a change in the actual yaw rate generated when the control responding to the torque reduction amount is not performed.

After clockwise steering is started at the position A, when the torque reduction amount is increased as presented in the chart (e) along with an increase in clockwise steering speed, a load applied to the front road wheels 2 as steerable road wheels of the vehicle 1 is increased. As a result, a frictional force between each of the front road wheels 2 and a road surface is increased, and a cornering force of the front road wheels 2 is increased, thereby providing improved turn-in ability of the vehicle 1. That is, as depicted in the chart (g), in the intermediate zone between the position A and the position B, when the control of the engine 4 is performed to realize the final target torque reflecting the torque reduction amount (solid line), a larger clockwise (CW) yaw rate is generated in the vehicle 1, as compared to the case where the control responding to the torque reduction amount is not performed (dotted line).

In addition, as presented in the charts (d), (e), when the steering speed is gradually reduced toward the position B, the torque reduction amount is maintained at its maximum value, although the target additional deceleration is gradually reduced, so that it is possible to maintain the load applied to the front road wheels 2 and keep up the turn-in ability of the vehicle 1, as long as the tuning of the steering wheel is continued.

Further, when the absolute value of the steering angle is maintained constant during traveling from the position B to the position C, the torque reduction amount is smoothly reduced. Thus, in response to completion of the turning of the steering wheel, the load applied to the front road wheels 2 can be gradually reduced to gradually reduce the cornering force of the front road wheels 2, thereby restoring the output torque of the engine 4, while stabilizing a vehicle body.

Next, a description will be made about the threshold Ts used in the aforementioned engine control processing routine by the PCM 14 to stop the control for adding deceleration to the vehicle 1 based on the steering wheel manipulation (i.e., reduction of the output torque of the engine 4).

In order to find an appropriate setting value of the threshold Ts, the inventors conducted an experimental test for obtaining a driver's subjective evaluation for behavior of the vehicle 1 when the vehicle 1 is driven to travel along a straight road under each of a plurality of different thresholds Ts whose values were set to be incremented by 1 deg/s in the range of 1 deg/s to 8 degree/s. The test was conducted plural times by each of a plurality of drivers, and an average value of evaluation scores by the subjective evaluation was obtained. Test conditions were as follows.

Vehicle: Mazda AXELA (2014 model, front-wheel drive, with 1.5 L gasoline engine and automatic transmission)

Vehicle Weight: 1226 kg

Toe Angle: 0.11°±0° 20′

Steering Wheel Diameter: 36 cm

Test Course: 1.4-kilometer straight road

Vehicle Speed: 80 to 100 km/h

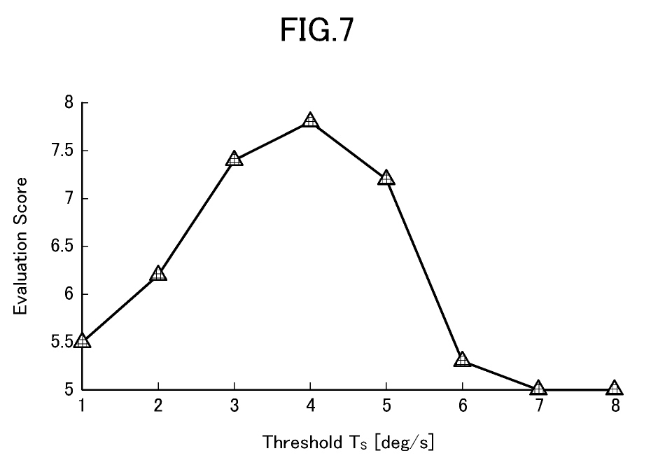

A result of the test is presented in FIG. 7. FIG. 7 is a graph presenting the driver's subjective evaluation for behavior of the vehicle 1 during straight-ahead traveling, performed by variously changing the threshold Ts. In FIG. 7, the horizontal axis represents the threshold Ts, and the vertical axis represents an evaluation score with respect to the behavior of the vehicle 1. The subjective evaluation was performed such that each of the drivers gives the score to feeling of the manipulation of the steering wheel 6, and the behavior of the vehicle 1 (responsivity and stability). Regarding the evaluation score, for example, 5 means a level at which the vehicle behavior has a bad reputation in the market but only among a small number of people, and 6 and 7 means, respectively, a level at which it has almost neither bad reputation nor good reputation, and a level at which it has a fairly good reputation.

As presented in FIG. 7, in the case where the threshold Ts is set to a value of less than 3 deg/s, the evaluation score gradually decreases as the threshold Ts is set to a smaller value, and stays at about 6. This is because, in the case of using the threshold Ts set in this range, even when a relatively slow and small manipulation of the steering wheel is performed, the PCM 14 operates to reduce the torque to thereby provide improved turn-in ability of the vehicle 1, so that, in some cases, each of the drivers felt that vehicle behavior responsive to the steering manipulation during straight-ahead traveling was too sensitive and thus straight-ahead traveling performance had degraded. Moreover, the torque reduction causes an increase in cornering force of the vehicle 1 and accordingly causes an increase in reaction force against steering, so that, in some cases, each of the drivers felt uncomfortable due to a resistive force around a neutral position of the steering wheel 6.

Further, in the case where the threshold Ts is set to a value of greater than 5 deg/s, the evaluation score sharply decreases as the threshold Ts is set to a larger value, and stays at about 5. This is because, in the case of using the threshold Ts set in this range, the range of the steering speed in which the PCM 14 does not operate to reduce the torque is excessively wide, and thereby a delay occurs between a time when each of the drivers starts to manipulate the steering wheel and a time when the PCM 14 starts to reduce the torque, so that, in some cases, the driver felt that responsivity of the vehicle 1 with respect to the steering wheel manipulation during straight-ahead traveling was poor or unreliable, or felt that the manipulation of the steering wheel 6 during straight-ahead traveling was discontinuous.

On the other hand, in the case where the threshold Ts is set in the range of 3 deg/s to 5 deg/s, a high level of evaluation in which the evaluation score is more than 7 was obtained. In the case of using the threshold Ts set in this range, as a result of good balance between the responsivity of the vehicle 1 with respect to the steering wheel manipulation during straight-ahead traveling, and the feeling of the manipulation of the steering wheel 6, the high level of evaluation could be obtained. Particularly, in the case where the threshold Ts is set to 4 deg/s, the behavior of the vehicle 1 is controlled with good responsivity with respect to steering wheel manipulation for maintain straight-ahead traveling, while keeping the vehicle 1 from excessively responding to a small manipulation of the steering wheel during straight-ahead traveling. This makes it possible for each of the drivers to easily maintain a straight-ahead traveling state, while being enabled to feel that the manipulation of the steering wheel 6 is stable but not too heavy. Thus, a highest level of evaluation could be obtained.

Next, some modifications of the above embodiment will be described.

Although the above embodiment has been described based on an example in which the torque reduction amount-determining part 18 is configured to obtain the target additional deceleration based on the steering speed, and determine the torque reduction amount based on the obtained target additional deceleration, the torque reduction amount-determining part 18 may be configured to determine the torque reduction amount based on any driving state of the vehicle 1 other than the manipulation of the accelerator pedal (e.g., steering angle, yaw rate, or slip ratio).

For example, the torque reduction amount-determining part 18 may be configured to calculate, as the yaw rate-related quantity, a target yaw acceleration to be generated in the vehicle 1, based on a target yaw rate calculated from the steering wheel angle and the vehicle speed, and a yaw rate input from a yaw rate sensor, and obtain the target additional deceleration based on the calculated target yaw acceleration to determine the torque reduction amount. Alternatively, it is also possible to detect, by an acceleration sensor, a lateral acceleration to be generated in the vehicle 1 along with turning of the vehicle 1, as the yaw rate-related quantity, and determine the torque reduction amount based on the detected lateral acceleration.

The above embodiment has been described based on an example in which the vehicle 1 equipped with the vehicle behavior control device has the engine 4 for driving drive road wheels. However, the vehicle behavior control device of the present invention may also be applied to a vehicle having a motor for driving the drive road wheels by electric power supplied from a battery or a capacitor. In this case, the PCM 14 may be configured to perform control to reduce a torque of the motor according to the steering speed of the vehicle 1.

Next, advantageous effects of the vehicle behavior control device according to the above embodiment and the modifications thereof will be described.

First, the PCM 14 is configured, under the condition that the steering speed is greater than the predetermined threshold Ts, and when the steering angle of the vehicle 1 is increasing, and the steering speed is increasing, to perform control to gradually increase an amount of reduction of torque for driving the vehicle 1, along with an increase in the steering speed, and, under the condition that the steering speed is equal to or less than the threshold T_{S}, to perform control to stop the reduction of the torque. Thus, under the condition that the steering speed is greater than the predetermined threshold Ts, the torque can be reduced by an amount according to the steering speed to thereby add deceleration to the vehicle 1 to quickly apply a load to the vehicle 1, so that it is possible to control behavior of the vehicle 1 with good responsivity with respect to intentional manipulation of the steering wheel by a driver. On the other hand, under the condition that the steering speed is equal to or less than the threshold, it is possible to suppress a situation where the vehicle 1 excessively responds to a small manipulation of the steering wheel. This makes it possible to perform the control of behavior of the vehicle 1 to accurately realize vehicle behavior intended by the driver, without causing the driver to feel uncomfortable in vehicle behavior during straight-ahead traveling.

Particularly, the threshold Ts is set in the range of 3 deg/s to 5 deg/s, more preferably at 4 deg/s. Thus, it is possible to prevent a situation where a driver feels that behavior of the vehicle 1 responsive to the steering manipulation during straight-ahead traveling is too sensitive and thus straight-ahead traveling performance has degraded, or a situation where a driver feels that responsivity of the vehicle 1 with respect to the steering wheel manipulation during straight-ahead traveling is poor or unreliable. Further, it is possible to prevent the driver from feeing that the manipulation of the steering wheel 6 during straight-ahead traveling is too heavy or discontinuous. This makes it possible to perform the control of behavior of the vehicle 1 to accurately realize vehicle behavior intended by the driver, while reliably preventing the disadvantage of causing the driver to feel uncomfortable in vehicle behavior during straight-ahead traveling.

Further, the PCM 14 is configured, under the condition that the steering speed is greater than the predetermined threshold Ts, and when the steering angle of the vehicle 1 is increasing, and the steering speed is increasing, to perform control to gradually reduce an increase rate of the torque reduction amount along with an increase in the steering speed. Thus, when steering of the vehicle 1 is started and thus the steering speed of the vehicle 1 starts increasing, the torque reduction amount can be quickly increased to thereby quickly add deceleration to the vehicle 1 at start of steering of the vehicle 1 to quickly apply a sufficient load to front road wheels 2 as steerable road wheels. As a result, a frictional force between each of the front road wheels 2 as steerable road wheels and a road surface is increased, and thus a cornering force of the front road wheels 2 is increased, so that it is possible to improve turn-in ability of the vehicle 1 in an initial phase after entering a curve. This makes it possible to improve responsiveness to the turning manipulation of the steering wheel, while reliably preventing the disadvantage of causing the driver to feel uncomfortable in vehicle behavior during straight-ahead traveling.

### LIST OF REFERENCE SIGNS

1: vehicle
2: front road wheel
4: engine
6: steering wheel
8: steering angle sensor
10: accelerator position sensor
12: vehicle speed sensor
14: PCM
16: basic target torque-determining part
18: torque reduction amount-determining part
20: final target torque-determining part
22: engine control part

What is claimed is:

1. A vehicle behavior control device for controlling behavior of a vehicle having steerable front road wheels, comprising
a steering angle sensor; and
a driving force control part configured to control the vehicle to reduce driving force for the vehicle, according to yaw rate-related quantity which is related to yaw rate of the vehicle,
wherein the driving force control part is configured, under a condition that the yaw rate-related quantity is greater than a predetermined threshold, and when a steering angle of the vehicle is increasing, and the yaw rate-related quantity is increasing, to control the vehicle to gradually increase an amount of reduction of the driving force for the vehicle, along with an increase in the yaw rate-related quantity, and, under a condition that the yaw rate-related quantity is equal to or less than the threshold, to control to stop the reduction of the driving force.

2. The vehicle behavior control device as recited in claim 1, wherein the yaw rate-related quantity is a steering speed of the vehicle, and wherein the threshold is set in the range of 3 deg/s to 5 deg/s.

3. The vehicle behavior control device as recited in claim 2, wherein the threshold is set at 4 deg/s.

4. The vehicle behavior control device as recited in claim 1, wherein the yaw rate-related quantity is a yaw acceleration of the vehicle.

5. The vehicle behavior control device as recited in claim 1, wherein the driving force control part is configured, under the condition that the yaw rate-related quantity is greater than the threshold, and when the steering angle of the vehicle is increasing, and the yaw rate-related quantity is increasing, to control the vehicle to gradually reduce an increase rate of the driving force reduction amount along with an increase in the yaw rate-related quantity.

6. An automotive vehicle control device comprising a steering angle sensor, an accelerator position sensor, a vehicle speed sensor and a controller configured to receive input including at least steering angle, accelerator position, and vehicle speed, and, based on the input, control driving force to be output from a driving force generating device of the automotive vehicle,
wherein the controller is configured:
when the steering angle is increasing, and a steering angular speed is not decreasing, to reduce the driving force to generate additional deceleration corresponding to the steering angular speed by referring to a map defining the additional deceleration which is preliminarily set correspondingly to each value of the steering angular speed greater than a predetermined threshold;
when the steering angle is increasing, and the steering angular speed is decreasing, to reduce the driving force to generate a value of the additional deceleration corresponding to a maximum value of the steering angular speed; and,
when the steering angle is not increasing, to increase the driving force to reduce the additional deceleration,
and wherein, in the map, the additional deceleration is set such that, as the steering angular speed becomes larger, the additional deceleration itself gradually increases, and an increase rate of the additional deceleration gradually decreases, and the threshold is set in the range of 3 deg/s to 5 deg/s.
